(19) United States
(12) Patent Application Publication
(10) Pub. No.: US 2025/0078654 A1
(43) Pub. Date: Mar. 6, 2025

(54) SIGNAL CONTROL SYSTEM, METHOD FOR CREATING SIGNAL CONTROL SCHEDULE, AND RECORDING MEDIUM

(71) Applicant: NEC Corporation, Minato-ku, Tokyo (JP)

(72) Inventor: Nobuyuki TOZAWA, Tokyo (JP)

(73) Assignee: NEC Corporation, Minato-ku, Tokyo (JP)

(21) Appl. No.: 18/725,859

(22) PCT Filed: Jan. 24, 2022
(86) PCT No.: PCT/JP2022/002340

§ 371 Date: Jul. 1, 2024

(51) Int. Cl. G08G 1/08; G08G 1/01; G08G 1/09

(52) U.S. Cl. CPC G08G 1/08; G08G 1/0129; G08G 1/0141; G08G 1/09

(57) ABSTRACT

A signal control system comprising a data acquiring unit that acquires traffic status data related to movements of a vehicle and a pedestrian at an intersection for a predetermined time in the past, a first calculating unit that calculates a first evaluation value based on the traffic status data, and a creating unit that creates, based on the first evaluation value, a signal control schedule, including timing at which signal pedestrian-and-vehicle separation type signal control is to be performed at the intersection.

### TECHNICAL FIELD

The present invention relates to a signal control system, a method for creating a signal control schedule, and a recording medium.

### BACKGROUND ART

As a measure to reduce a pedestrian-and-vehicle accident between a vehicle and a pedestrian, a pedestrian-and-vehicle separation type signal control (including a scrambling method that allows a pedestrian to diagonally cross an intersection) capable of temporally separating traffic lines of the pedestrian and the vehicle has attracted attention. The pedestrian-and-vehicle separation type signal control has an aspect that worsens traffic congestion because a time for inhibiting movement of the vehicle is provided for a certain period during a signal control cycle.

On the other hand, depending on an intersection, there is a case where traffic becomes smoother in the pedestrian-and-vehicle separation type signal control. For example, in an intersection where an amount of pedestrians at a crosswalk is large and a vehicle that turns right or left during a green light emission time is forced to stop due to pedestrian crossing, the pedestrian-and-vehicle separation type signal control is considered to be more advantageous.

PTL 1 discloses a moving person monitoring device capable of controlling a vehicle traffic light and a pedestrian traffic light more efficiently by examining a situation and the number of pedestrians at an intersection of a road.

### CITATION LIST

### Patent Literature

PTL 1: JP 11-275562 A

### SUMMARY OF INVENTION

### Technical Problem

In the moving person monitoring device of PTL 1, the pedestrian traffic light and the vehicle traffic light are controlled based on the number of pedestrians (hereinafter, “a pedestrian or the like waiting at a traffic light”) waiting for crossing near the pedestrian traffic light and the waiting time. For this reason, when there are many pedestrians and the like waiting at a traffic light, a right or left turn of the vehicle may be hindered, and a traffic jam may occur.

An object of the present invention is to provide a signal control system, a method for creating a signal control schedule, and a recording medium that can contribute to both reduction of a pedestrian-and-vehicle accident and smoothing of road traffic.

### Solution to Problem

According to a first point of view, there is provided a signal control system including a data acquiring means for acquiring traffic status data related to the movements of a vehicle and a pedestrian at an intersection for a predetermined time in the past, a first calculating means for calculating a first evaluation value based on the traffic status data, and a creating means for creating, based on the first evaluation value, a signal control schedule including timing at which pedestrian-and-vehicle separation type signal control is to be performed at the intersection.

According to a second point of view, there is provided a method for creating a signal control schedule including acquiring traffic status data related to movements of a vehicle and a pedestrian at an intersection for a predetermined time in the past, calculating a first evaluation value based on the traffic status data, and creating, based on the first evaluation value, a signal control schedule for performing pedestrian-and-vehicle separation type signal control at the intersection.

According to a third point of view, there is provided a computer-readable recording medium storing a program for causing a computer to execute: a process of acquiring traffic status data related to movements of a vehicle and a pedestrian at an intersection for a predetermined time in the past, a process of calculating a first evaluation value based on the traffic status data, and a process of creating, based on the first evaluation value, a signal control schedule for performing pedestrian-and-vehicle separation type signal control at the intersection.

### Advantageous Effects of Invention

According to the present invention, there are provided a signal control system, a method for creating a signal control schedule, and a recording medium that can contribute to both reduction of a pedestrian-and-vehicle accident and smoothing of road traffic.

### BRIEF DESCRIPTION OF DRAWINGS

FIG. 1 is a diagram illustrating a configuration of one example embodiment of the present invention.

FIG. 2 is a diagram for explaining basic data for calculating a first evaluation value used in one example embodiment of the present invention.

FIG. 3 is a diagram for explaining basic data for calculating the first evaluation value used in one example embodiment of the present invention.

FIG. 4 is a diagram for explaining basic data for calculating the first evaluation value used in one example embodiment of the present invention.

FIG. 5 is a flowchart illustrating operation of one example embodiment of the present invention.

FIG. 6 is a diagram illustrating an example of a signal control schedule created by a signal control system of one example embodiment of the present invention.

FIG. 7 is a diagram illustrating another example of the signal control schedule created by the signal control system of one example embodiment of the present invention.

FIG. 8 is a diagram illustrating a configuration of a first example embodiment of the present invention.

FIG. 9 is a signal cycle diagram of a traffic light used for describing the first example embodiment of the present invention.

FIG. 10 is an example of a left-turning vehicle waiting time cumulative value calculated by the signal control system of the first example embodiment of the present invention.

FIG. 11 is an example of a signal control schedule created by a signal control system of the first example embodiment of the present invention.

FIG. 12 is a diagram illustrating an example of a change in display content of a display board by the signal control system of the first example embodiment of the present invention.

FIG. 13 is an example of a signal cycle diagram switched by the signal control system of the first example embodiment of the present invention.

FIG. 14 is a flowchart illustrating operation of the signal control system of the first example embodiment of the present invention.

FIG. 15 is a diagram illustrating a configuration of a second example embodiment of the present invention.

FIG. 16 is an example of a left-turning vehicle waiting time cumulative value calculated by a signal control system of the second example embodiment of the present invention.

FIG. 17 is an example of a signal control schedule created by the signal control system of the second example embodiment of the present invention.

FIG. 18 is a flowchart illustrating operation of the signal control system of the second example embodiment of the present invention.

FIG. 19 is a diagram illustrating a configuration of a third example embodiment of the present invention.

FIG. 20 is a diagram illustrating an example of a display mode of a vehicle on an in-vehicle terminal by a signal control system of a third example embodiment of the present invention.

FIG. 21 is a diagram illustrating another example of the display mode of the vehicle on the in-vehicle terminal by the signal control system of the third example embodiment of the present invention.

FIG. 22 is an example of a signal cycle diagram switched by a signal control system of a fourth example embodiment of the present invention.

FIG. 23 is a signal cycle diagram for describing the fourth example embodiment of the present invention.

FIG. 24 is an example of a signal cycle diagram switched by the signal control system of the fourth example embodiment of the present invention.

FIG. 25 is a diagram illustrating a configuration of a computer constituting the signal control system of the present invention.

### EXAMPLE EMBODIMENT

First, an outline of one example embodiment of the present invention will be described with reference to the drawings. Drawing reference signs in the summary are given to each element for convenience as examples solely for facilitating understanding, and are not intended to limit the present invention to the illustrated aspects. Also, connecting lines between blocks in the drawings and the like referred to in the following description include both bidirectional and unidirectional. One-way arrows schematically show a flow of a main signal (data), and does not exclude bidirectionality. A program is executed via a computer device, and the computer device includes, for example, a processor, a storage device, an input device, a communication interface, and a display device as necessary. The computer device is configured to be able to communicate with a device (including a computer) inside or outside the device via a communication interface regardless of wired or wireless. Although there are ports and interfaces at connection points of input and output of each block in the drawing, illustration thereof is omitted.

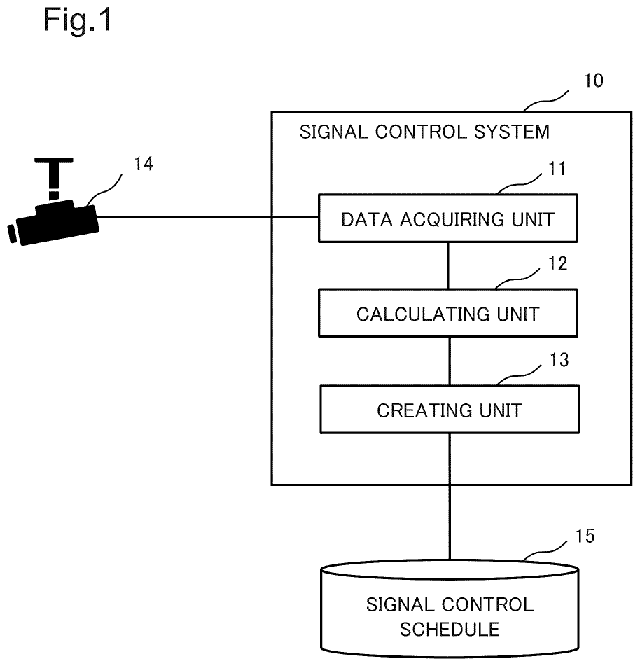

In one example embodiment of the present invention, as illustrated in FIG. 1, the present invention can be achieved by a signal control system 10 including a data acquiring means 11, a calculating means 12, and a creating means 13.

More specifically, the data acquiring means 11 acquires traffic status data for a predetermined time in the past related to movements of a vehicle and a pedestrian at an intersection. The traffic status data may be, for example, a moving image in which movements of the vehicle and the pedestrian taken by a camera 14 are recorded, or may be data obtained by analyzing the moving image.

The calculating means 12 (first calculating means) calculates a first evaluation value based on the traffic status data. As the first evaluation value, a statistical value indicating a degree of stay of the vehicle due to intersection of traffic lines of the vehicle and the pedestrian in the predetermined time in the past can be used.

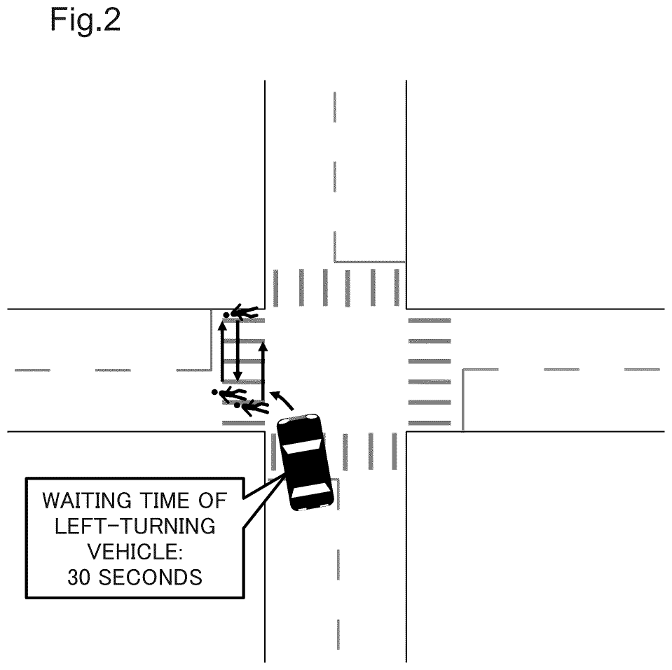

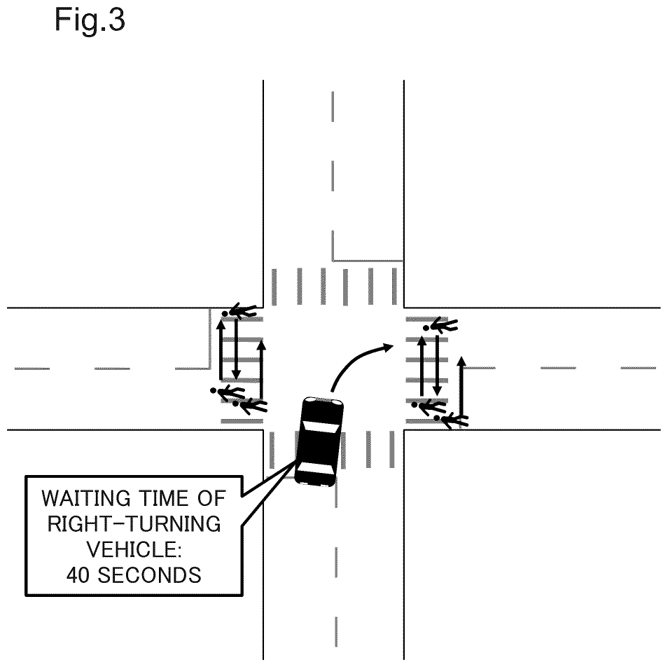

FIGS. 2 and 3 are diagrams for explaining basic data for calculating the first evaluation value. An arrow in the drawing indicates a traffic line of a vehicle turning right or left and a pedestrian crossing a crosswalk. The traffic lines and movements of the vehicle and the pedestrian as illustrated in FIGS. 2 and 3 can be obtained by recognizing the vehicle and the pedestrian as objects from a moving image taken by the camera 14 and tracking the movements. Then, as the basic data of the first evaluation value, as illustrated in FIG. 2, it is possible to use a time during which a left-turning vehicle stops when turning left and a time required for turning left. Furthermore, as the basic data of the first evaluation value, as illustrated in FIG. 3, it is possible to use a time during which a right-turning vehicle stops when turning right and a time required for turning right. Then, for example, the first estimation value can be calculated from a statistical value (total, average, mode, etc.) of these values. In the examples of FIGS. 2 and 3, an example of a road with one lane on each side is illustrated, and the first evaluation value can be similarly calculated even for a road with two or more lanes on each side.

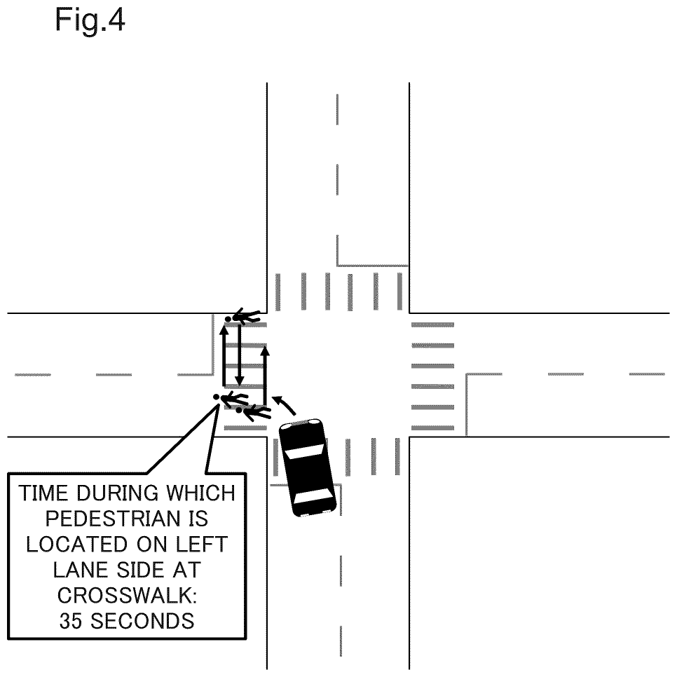

The first evaluation value can also be calculated using a statistical value (total, average, mode, etc.) of a time during which a pedestrian at a crosswalk located ahead of a left turn of a left-turning vehicle is located on the crosswalk in the predetermined time in the past. For example, as illustrated in FIG. 4, in the case of left-hand traffic, if a pedestrian is located on a left lane side at a crosswalk located ahead of a left turn, the traffic of the left-turning vehicle is hindered. Thus, the first evaluation value can be calculated using a statistical value (total, average, mode, etc.) of a time during which a pedestrian is located in the left lane on the crosswalk and a time during which the pedestrian occupies the left lane on the crosswalk in the predetermined time in the past.

The first evaluation value can also be calculated using the number of vehicles staying in a left turn lane or a right turn lane in the predetermined time in the past or a length of the train. The first evaluation value in this case can also be calculated using the statistical value (total, average, mode, etc.) of the number of vehicles and the length of the train.

The calculating means 12 (first calculating means) described above may be configured to calculate the first evaluation value for each of the lanes facing each other at the intersection.

The creating means 13 creates a signal control schedule 15 including timing at which pedestrian-and-vehicle separation type signal control is performed at the intersection based on the first evaluation value.

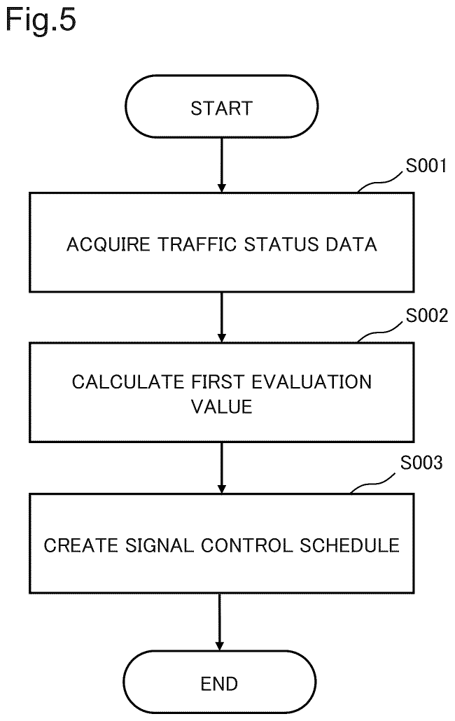

The signal control system 10 described above operates as illustrated in FIG. 5. First, the signal control system 10 acquires traffic status data in the predetermined time in the past related to the movements of the vehicle and the pedestrian at the intersection (step S101). Next, the signal control system 10 calculates the first evaluation value in the predetermined time in the past based on the traffic status data (step S102). Next, the signal control system 10 creates a signal control schedule for performing the pedestrian-and-vehicle separation type signal control at the intersection based on the first evaluation value (step S103).

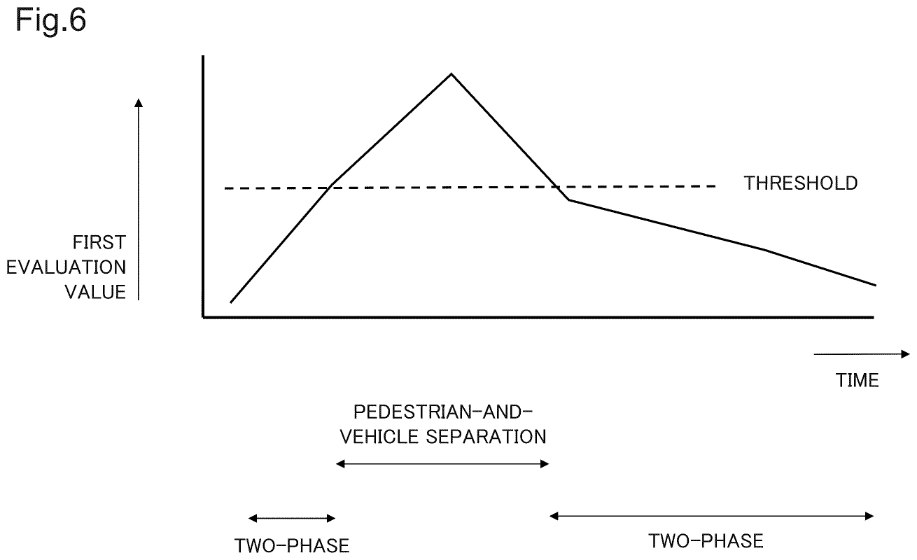

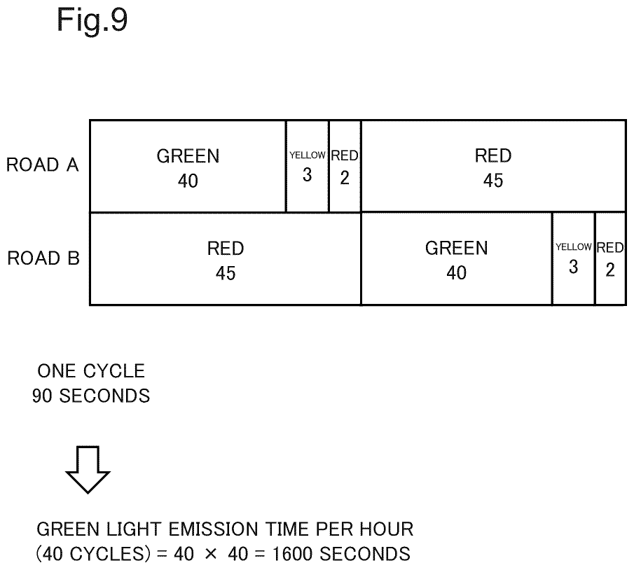

FIG. 6 is a diagram illustrating an example of the signal control schedule created by the signal control system 10 of one example embodiment of the present invention. The description will be given assuming that “two-phase” in FIG. 6 is a two-phase method for switching between red light emission and green light emission with respect to a traffic flow intersecting at an intersection (see a signal cycle diagram in FIG. 9). In addition, a three-phase method or a four-phase method in which a green arrow is combined in addition to red light emission is known; however, in the present specification, the two phase is used as an example of a phase method other than a pedestrian-and-vehicle separation method. Naturally, it is also possible to use the three-phase method or the four-phase method as the phase method other than the pedestrian-and-vehicle separation method.

In the example of FIG. 6, the signal control system 10 creates a schedule for switching between signal control methods from the two-phase method to the pedestrian-and-vehicle separation method when the first evaluation value exceeds a predetermined threshold. After switching to the pedestrian-and-vehicle separation method, the traffic lines of the vehicle and the pedestrian do not intersect in principle. For this reason, the first evaluation value during switching to the pedestrian-and-vehicle separation method is estimated as the first evaluation value in the case of the two-phase method based on the movements of the vehicle and the pedestrian. The signal control schedule of FIG. 6 may be a signal control schedule per day created based on the traffic status data in the predetermined time in the past, or may be a signal control schedule in a predetermined time from the present, for example, several hours from the present. For example, the signal control system 10 may create a signal control schedule for intermittently adopting the pedestrian-and-vehicle separation type signal control such that the signal control method is switched to the pedestrian-and-vehicle separation method from the current time point to 30 minutes later. In either case, by using the signal control schedule as described above, it is possible to reduce both a pedestrian-and-vehicle accident between the vehicle and the pedestrian and stay of the vehicle turning right or left.

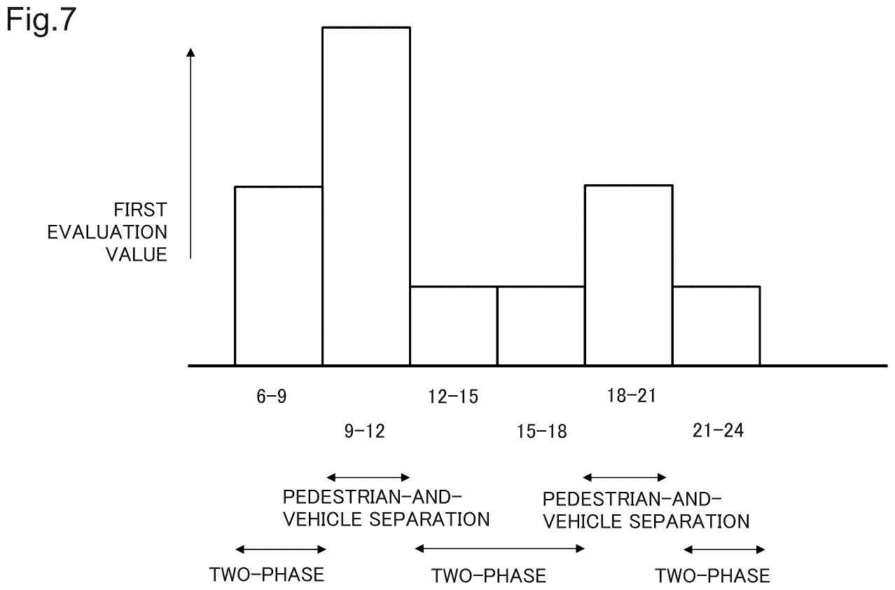

FIG. 7 is a diagram illustrating another example of the signal control schedule created by the signal control system 10 of one example embodiment of the present invention. In the example of FIG. 7, the signal control system 10 calculates the first evaluation value for each time zone based on the traffic status data, and creates a signal control schedule for switching between the signal control methods for each time zone. By using such a signal control schedule as a signal control schedule for the next day or the same day of the next week, it is possible to reduce both the pedestrian-and-vehicle accident between the vehicle and the pedestrian and the stay of the vehicle turning right or left. In addition, such a signal control schedule can be used not only as a signal control schedule of a corresponding intersection but also as a signal control schedule of an adjacent intersection or another intersection having similar traffic conditions.

### First Example Embodiment

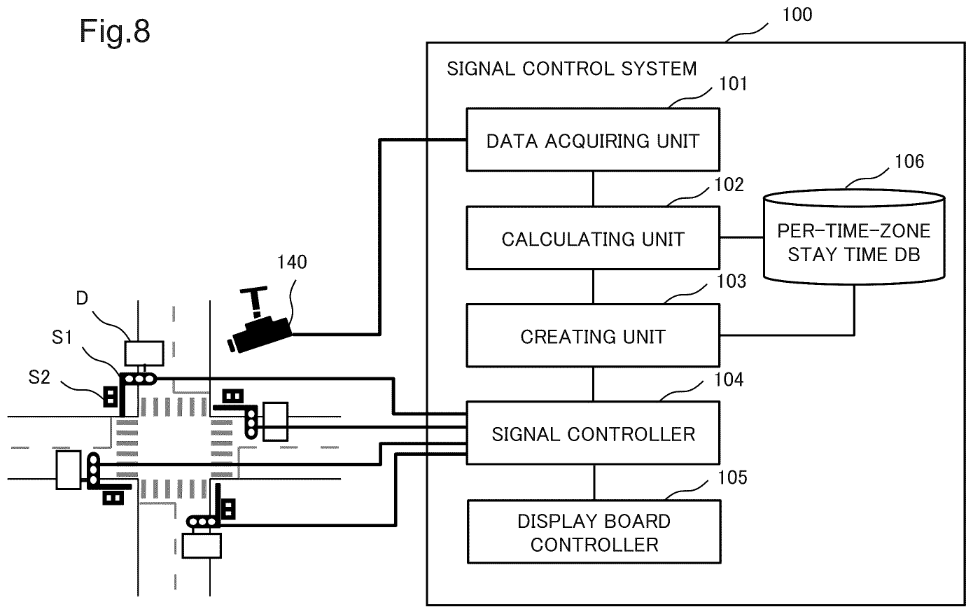

Next, a first example embodiment in which a signal control system controls a traffic light at an intersection will be described in detail with reference to the drawings. FIG. 8 is a diagram illustrating a configuration of the first example embodiment of the present invention. Referring to FIG. 8, a configuration including an intersection where a vehicle traffic light S1, a pedestrian traffic light S2, and a display board D are installed, a signal control system 100 that controls them, and a camera 140 that takes a picture of the intersection is illustrated.

One or more of the cameras 140 are installed at positions where the vehicle passing through the intersection illustrated in FIG. 8 and the pedestrian crossing the crosswalk can be photographed.

The signal control system 100 includes a data acquiring means 101, a calculating means 102, a creating means 103, a signal controller 104, a display board controller 105, and a per-time-zone stay time database (per-time-zone stay time DB) 106. The signal control system 100 may be a signal control device disposed at each of one or more intersections or a device functioning as an MEC (Multi-access Edge Computing) server. Furthermore, the signal control system 100 may be a device disposed in a traffic control system that controls traffic lights and signal control devices at a plurality of intersections.

The data acquiring means 101 acquires an image obtained by photographing a vehicle passing through the intersection and a pedestrian crossing the crosswalk from the camera 140 as the traffic status data in the predetermined time in the past related to the movements of the vehicle and the pedestrian at the intersection.

The calculating means 102 calculates the first evaluation value based on the image acquired by the data acquiring means 101, and records the first evaluation value in the per-time-zone stay time DB106. Specifically, the calculating means 102 measures a left turn waiting time when a left-turning vehicle waits for passage of a pedestrian in front of a crosswalk located ahead of a left turn of the left-turning vehicle for each cycle based on an image obtained by photographing the vehicle passing through the intersection and the pedestrian crossing the crosswalk from the camera 140. Then, the calculating means 102 aggregates the measured left turn waiting time for each time zone to calculate the first evaluation value for each time zone.

FIG. 9 is a signal cycle diagram of a traffic light at an intersection where a road A and a road B shown as an example intersect. In the case of this traffic light, one cycle is 90 seconds, the numerical value in the figure indicates an assigned time (seconds), and a split is equally distributed to each of the road A and the road B. In this case, a green light emission time applied to the road A (road B) per cycle is 40 seconds. Thus, the green light emission time per hour is 1600 seconds. In the present example embodiment, a cumulative value (total value) of a time during which the left-turning vehicle stops to wait for the pedestrian to cross in a left-turning direction is used as the first evaluation value.

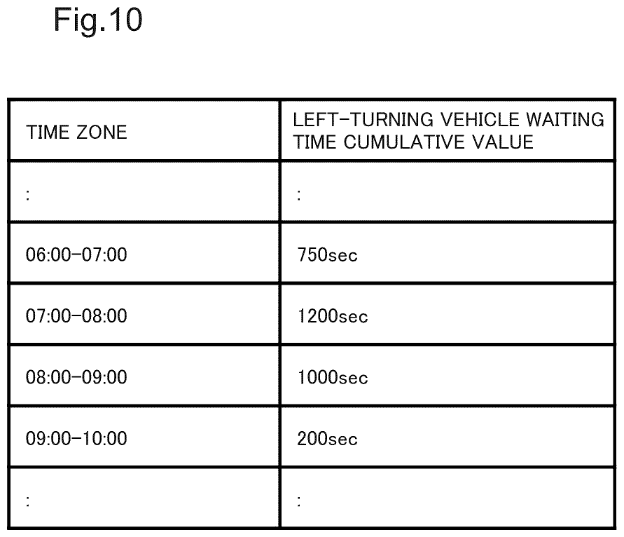

FIG. 10 is an example of a left-turning vehicle waiting time cumulative value for each time zone recorded in the per-time-zone stay time DB106. In the example of FIG. 10, the left-turning vehicle waiting time cumulative value is 750 seconds (sec) between 6:00 and 7:00 in the morning. Thereafter, between 7:00 and 8:00 in the morning, the left-turning vehicle waiting time cumulative value is 1200 seconds (sec). As described above, since the green light emission time per hour is 1600 seconds, 75% of the time is the time for waiting for a left turn. In such a case, it can be said that it is better to adopt the pedestrian-and-vehicle separation method. Similarly, the left-turning vehicle waiting time cumulative value is 1000 seconds (sec) between 8:00 and 9:00 in the morning.

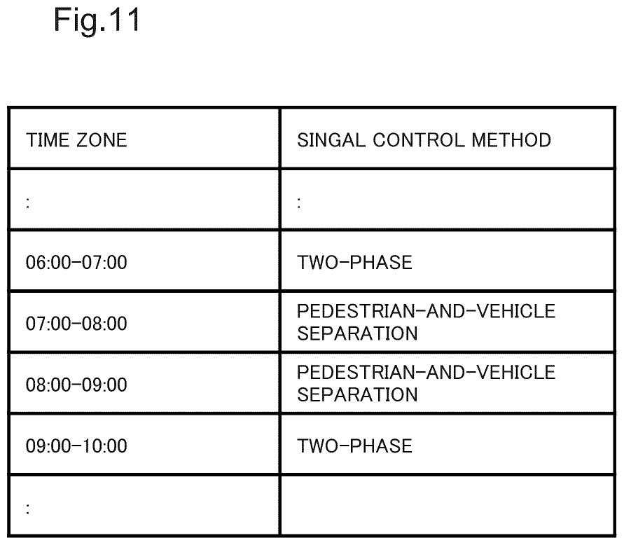

The creating means 103 determines a time zone in which the pedestrian-and-vehicle separation method is adopted based on the left-turning vehicle waiting time cumulative value for each time zone recorded in the per-time-zone stay time DB106, and creates a signal control schedule for each time zone. FIG. 11 is an example of a signal control schedule created using a policy of adopting the pedestrian-and-vehicle separation method in a case where the left-turning vehicle waiting time cumulative value is equal to or more than 1000 seconds. In the example of FIG. 11, a signal control schedule in which time zones of AM 7:00 to 8:00 and AM 8:00 to 9:00 in which the left-turning vehicle waiting time cumulative value is equal to or more than 1000 seconds in FIG. 10 is set as the pedestrian-and-vehicle separation method is created. On the other hand, in a time zone in which the left-turning vehicle waiting time cumulative value is less than 1000 seconds in FIG. 10, the two-phase method is maintained.

The signal controller 104 controls a vehicle traffic light S1 and a pedestrian traffic light S2 at the intersection according to the signal control schedule created by the creating means 103. Before changing the signal control method, the signal controller 104 instructs the display board controller 105 on the content to be displayed on the display board D.

The display board controller 105 changes a display content on the display board D according to the content instructed from the signal controller 104.

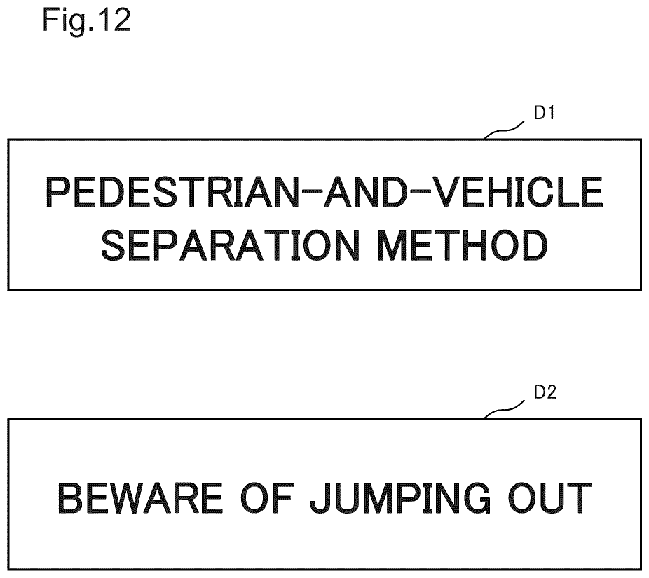

FIG. 12 is a diagram illustrating an example of a change in the display content on the display board D by the display board controller 105. For example, the display board controller 105 may display, on the display board D, the signal control method being performed at a traffic light at an intersection. When all the traffic lights at the intersection are operating by the pedestrian-and-vehicle separation method, the display board controller 105 displays “pedestrian-and-vehicle separation method” D1 on the display board D. On the other hand, when all the traffic lights at the intersection are operating by a method other than the pedestrian-and-vehicle separation method, the display board controller 105 displays a message to call attention to a driver, such as “beware of jumping out” D2, on the display board D. As the display board D, an electric-type display board using an LED (light emitting diode), a roll-type (mechanical) display board, or the like can be used. As the operation of the display board when all the traffic lights at the intersection are operating by a method other than the pedestrian-and-vehicle separation method, display control such as display of an intersection name, non-display, and turn-off may be performed in addition to displaying “beware of jumping out”. Naturally, a corresponding signal control method such as a “time-sequenced signal” or a “sensitive signal” may be displayed.

In addition to the display of the signal control method being performed described above, the display board controller 105 may display, on the display board, a remaining time until the emission of the signal in the signal control method being performed is switched using a counter or a figure. The display of the remaining time can take, for example, a mode of presenting the remaining time until the signal is switched by counter display of an inverse formula, or a mode of presenting the remaining time until the signal is switched by counter display of displaying an elapsed time together with a value of the split. Instead of the display of a remaining time or the like by the numerical value described above, a mode of presenting a time at which the signal is switched next by increasing or decreasing a gauge can also be adopted. In this way, a driver of a vehicle V can recognize that the traffic light at the intersection through which the vehicle is to pass is the traffic light that operates by the pedestrian-and-vehicle separation method and can recognize a time until the color of the light changes next.

As described above, by displaying the signal control method applied to the traffic light at the intersection, the driver of the vehicle and the pedestrian can predict the behavior of the traffic light at the intersection, and unnecessary jumping accidents and the like can be prevented.

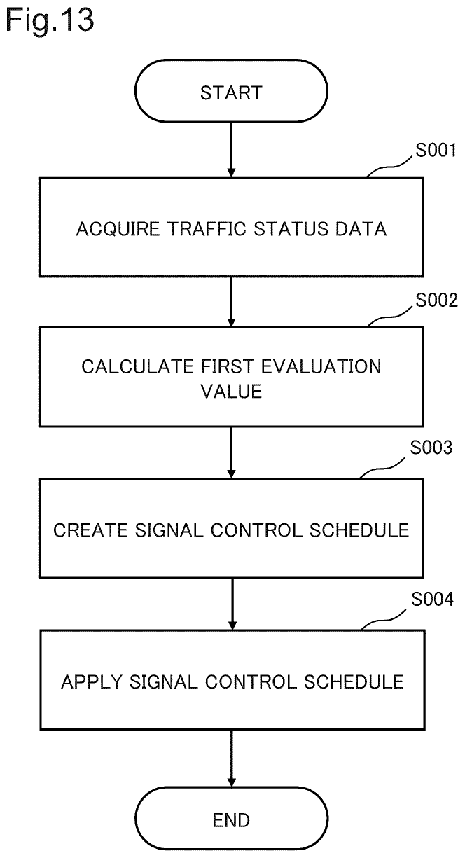

Next, the operation of the present example embodiment will be described in detail with reference to the drawings. FIG. 13 is a flowchart illustrating operation of the signal control system of the first example embodiment of the present invention. Referring to FIG. 13, first, the signal control system 100 acquires operation status data from the camera 140 (step S001).

Next, the signal control system 100 analyzes the operation status data and calculates the first evaluation value (step S002).

Next, the signal control system 100 creates a signal control schedule based on the calculated first evaluation value (step S003).

Next, the signal control system 100 applies the created signal control schedule and starts the control of the vehicle traffic light S1, the pedestrian traffic light S2, and the display board D (step S004).

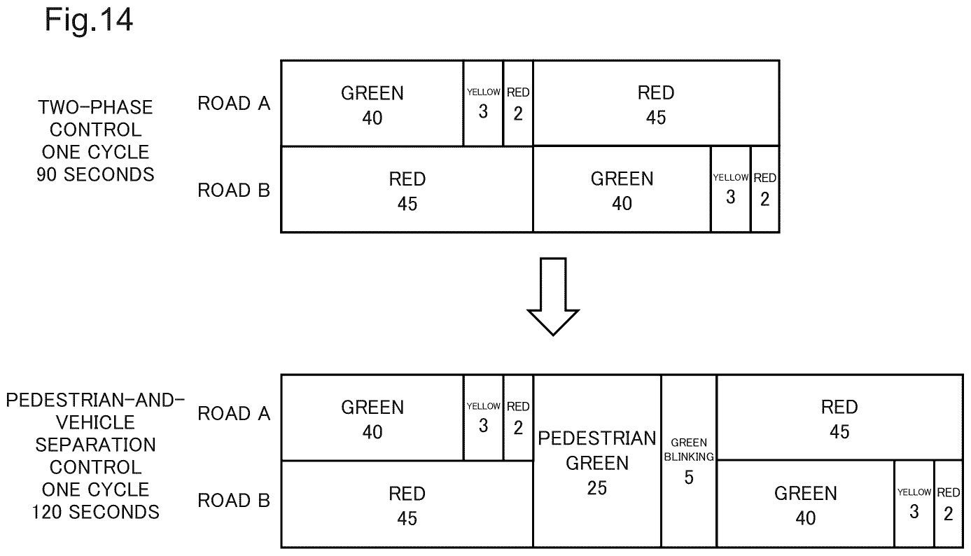

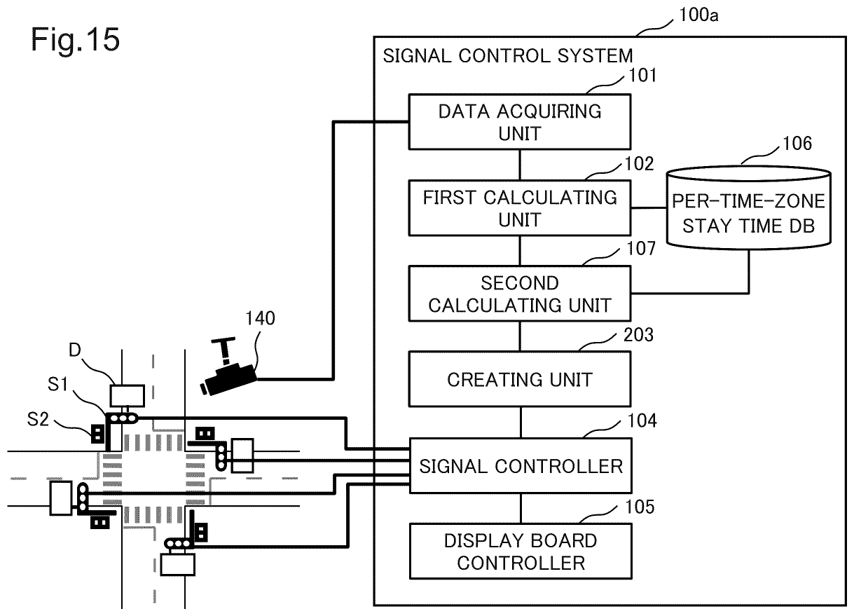

For example, when the pedestrian-and-vehicle separation method is selected based on the first evaluation value in a certain time zone, a signal cycle of the traffic light at the intersection is switched from contents in an upper part of FIG. 14 (two-phase method) to contents in a lower part of FIG. 15. In FIG. 14, a phase content of the pedestrian traffic light S2 is omitted. As a result, at the intersection, a time is provided during which all the display contents of the pedestrian traffic light S2 turn green during one cycle. In the example of FIG. 14, the green light emission time of 25 seconds and a green light blinking time of 5 seconds are inserted, and the signal cycle is switched to a signal cycle of 120 seconds as a whole. As a result, both reduction of a pedestrian-and-vehicle accident in a corresponding time zone of the intersection and smoothing of road traffic are achieved.

In the above description, the example has been described in which the policy of adopting the pedestrian-and-vehicle separation method is used in a case where the left-turning vehicle waiting time cumulative value is equal to or more than 1000 seconds; however, the policy for determining whether to adopt the pedestrian-and-vehicle separation method is not limited thereto. For example, the threshold and the policy can be changed as appropriate depending on an actual traffic volume, a statistical value to be adopted, and the like.

### Second Example Embodiment

Next, a second example embodiment will be described in detail with reference to the drawings in which an influence on a straight-running vehicle is also considered in determining the change of the signal control method. FIG. 15 is a diagram illustrating a configuration of the second example embodiment of the present invention. Differences from the configuration of the first example embodiment illustrated in FIG. 8 are that a second calculating means 107 that calculates a second evaluation value based on operation status data is added, and that creating means 203 creates a signal control schedule with reference to the second evaluation value in addition to the first evaluation value. Since the other configurations are similar to those of the first example embodiment, differences in the second example embodiment will be mainly described below.

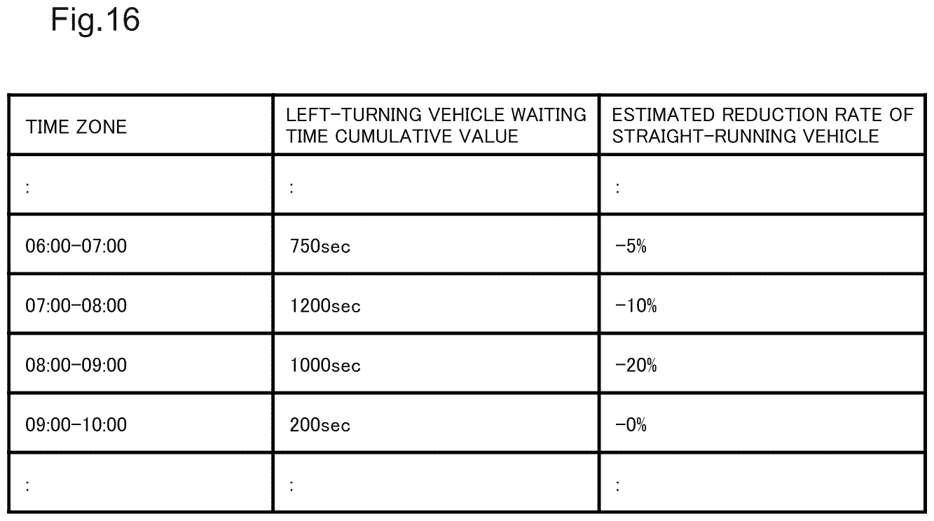

The second calculating means 107 calculates, based on the traffic status data, a second evaluation value indicating a degree of decrease in a traffic volume of the straight-running vehicles per unit time when the pedestrian-and-vehicle separation type signal control is employed at the intersection. For example, the degree of decrease in the traffic volume of the straight-running vehicles can be calculated using, for example, a difference between the traffic volume for each time zone of the straight-running vehicles according to a current signal control method (for example, two-phase method) and an estimated traffic volume in the same time zone when the pedestrian-and-vehicle separation method is adopted. For example, as illustrated in FIG. 16, the second calculating means 107 calculates a reduction rate of the traffic volume of the straight-running vehicle when the pedestrian-and-vehicle separation method is adopted in each time zone. For example, in a case where 100 straight-running vehicles can pass in the two-phase method, when the method is switched to the pedestrian-and-vehicle separation method and only 80 vehicles can pass, the reduction rate of the traffic volume of the straight-running vehicle is calculated to be −20%. Naturally, the second evaluation value may not be the reduction rate, but may be the number of straight-running vehicles expected to decrease after switching to the pedestrian-and-vehicle separation method, or the like.

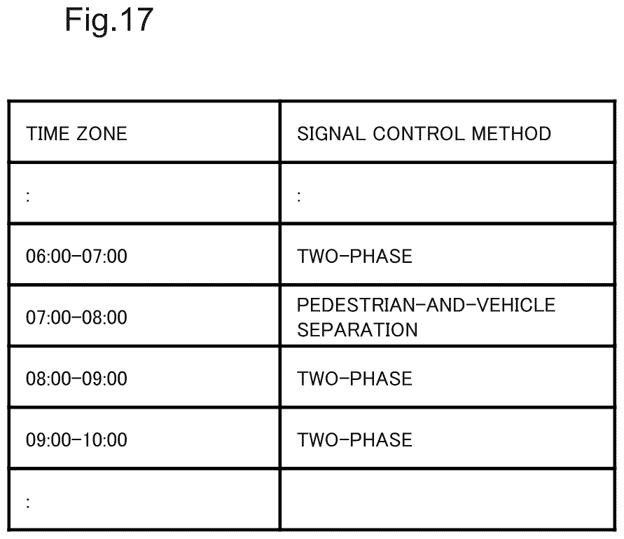

The creating means 203 creates, based on the first evaluation value and the second evaluation value, a signal control schedule for performing the pedestrian-and-vehicle separation type signal control at the intersection. FIG. 17 is an example of a signal control schedule created using a policy of adopting the pedestrian-and-vehicle separation method in a case where the left-turning vehicle waiting time cumulative value is equal to or more than 1000 seconds and the reduction rate of the straight-running vehicle is less than 20%. In the example of FIG. 17, a signal control schedule is created in which the pedestrian-and-vehicle separation method is used in the time zone of AM 7:00 to 8:00 in which the reduction rate of the straight-running vehicle is less than 20% in the time zone in which the left-turning vehicle waiting time cumulative value is equal to or more than 1000 seconds in FIG. 16. On the other hand, in FIG. 16, in the time zone in which the left-turning vehicle waiting time cumulative value is less than 1000 seconds or in a time zone in which the reduction rate of the straight-running vehicle in which the left-turning vehicle waiting time cumulative value is equal to or more than 1000 seconds is 20% or more, the two-phase method is maintained.

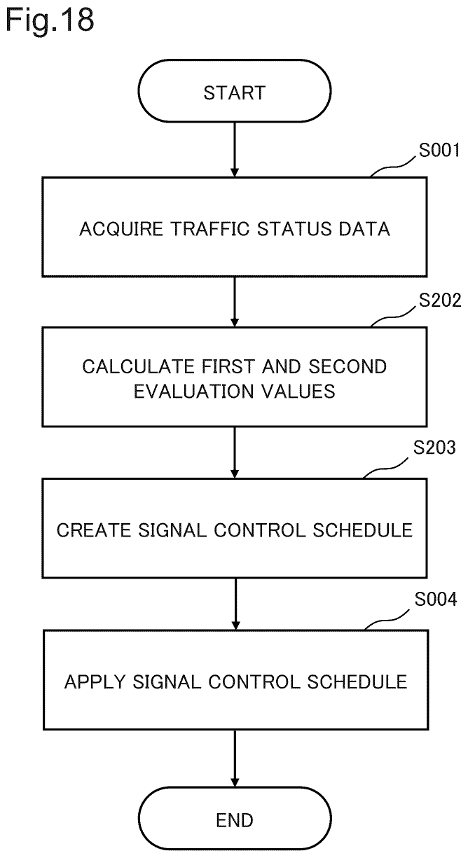

Next, the operation of the present example embodiment will be described in detail with reference to the drawings. FIG. 18 is a flowchart illustrating operation of a signal control system 100a of the second example embodiment of the present invention. A difference from FIG. 13 illustrating the operation of the first example embodiment is that the first and second evaluation values are calculated in step S202, and the signal control schedule is created based on the first and second evaluation values in step S203.

According to the second example embodiment operating as described above, it is possible to create a signal control schedule in consideration of not only the degree of stay of the vehicle that turns right or left due to the presence of the pedestrian but also the influence on the straight-running vehicle. For example, in the first example embodiment, the signal control schedule in which the pedestrian-and-vehicle separation method is adopted also in the time zone of AM 8:00 to 9:00 is created; however, as a result, it is possible to avoid a situation in which the traffic volume of the straight-running vehicle decreases.

In the above description, it has been described that the policy of adopting the pedestrian-and-vehicle separation method is used in the case where the left-turning vehicle waiting time cumulative value is equal to or more than 1000 seconds and the reduction rate of the straight-running vehicle is less than 20%; however, this is merely an example. The policy of determining whether to adopt the pedestrian-and-vehicle separation method is not limited thereto, and for example, the threshold and the policy can be appropriately changed according to the actual traffic volume, the statistical value to be adopted, and the like.

### Third Example Embodiment

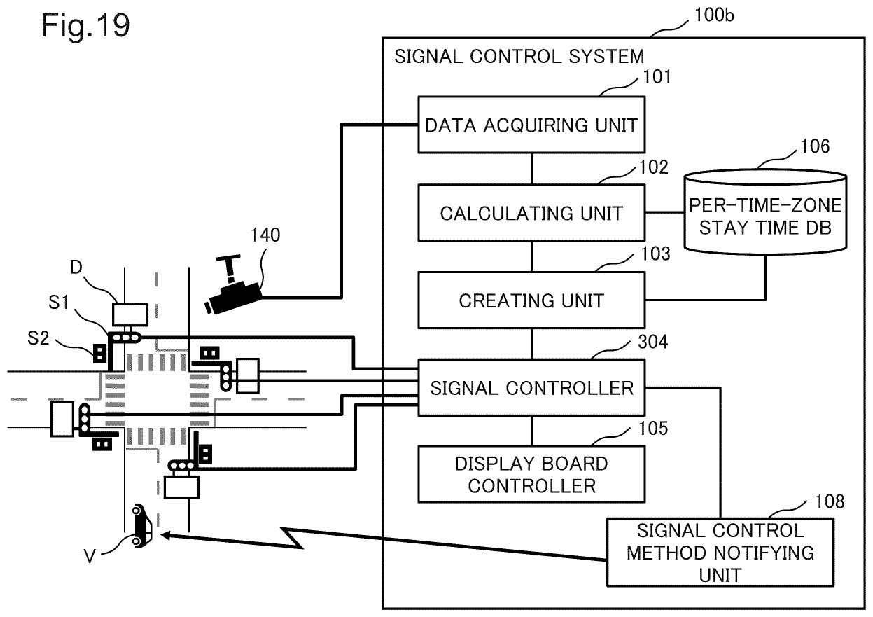

Next, a third example embodiment in which a function of notifying a vehicle approaching an intersection is added to a signal control system will be described in detail with reference to the drawings. FIG. 19 is a diagram illustrating a configuration of the third example embodiment of the present invention. A difference from the configuration of the first example embodiment illustrated in FIG. 8 is that a signal control method notifying means 108 is added to a signal control system 100b, and a signal controller 304 controls the signal control method notifying means 108. Since the other configurations are similar to those of the first example embodiment, differences in the second example embodiment will be mainly described below.

The signal controller 304 controls a vehicle traffic light S1 and a pedestrian traffic light S2 at the intersection according to the signal control schedule created by a creating means 103. Furthermore, the signal controller 304 instructs the signal control method notifying means 108 to notify the vehicle approaching the intersection of a signal control method and the like being performed at the traffic light at the intersection.

In accordance with the instruction from the signal controller 304, the signal control method notifying means 108 notifies the vehicle approaching the intersection of the signal control method and the like being performed at the traffic light at the intersection. Broadcast via a roadside device or a mobile communication network can be used as a method by which the signal control method notifying means 108 notifies the vehicle approaching the intersection of the signal control method and the like. In a more desirable mode, the signal control method notifying means 108 can include a range of a position of the vehicle on a reception side, identification information (ID) of the vehicle, and the like in the notification. In this way, the vehicle on the reception side can determine whether the information notified from the signal control system 100b is for a host vehicle by referring to the identification information for a position of the host vehicle.

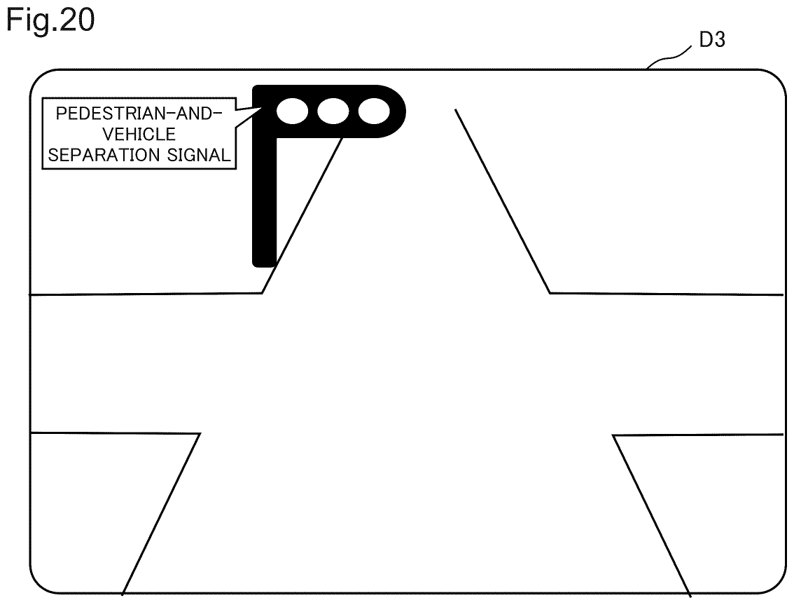

FIG. 20 is a diagram illustrating an example of a display mode of a vehicle on an in-vehicle terminal by the signal control system 100b of the present example embodiment. In the example of FIG. 20, a display of “pedestrian-and-vehicle separation signal” is added to the traffic light on a display screen D3 of the in-vehicle terminal of the vehicle V. In this way, the driver of the vehicle V can recognize that the traffic light at the intersection through which the vehicle is to pass is the traffic light that operates by the pedestrian-and-vehicle separation method. As a result, it is possible to prevent a hasty start and the like of the vehicle V after termination of the red light emission.

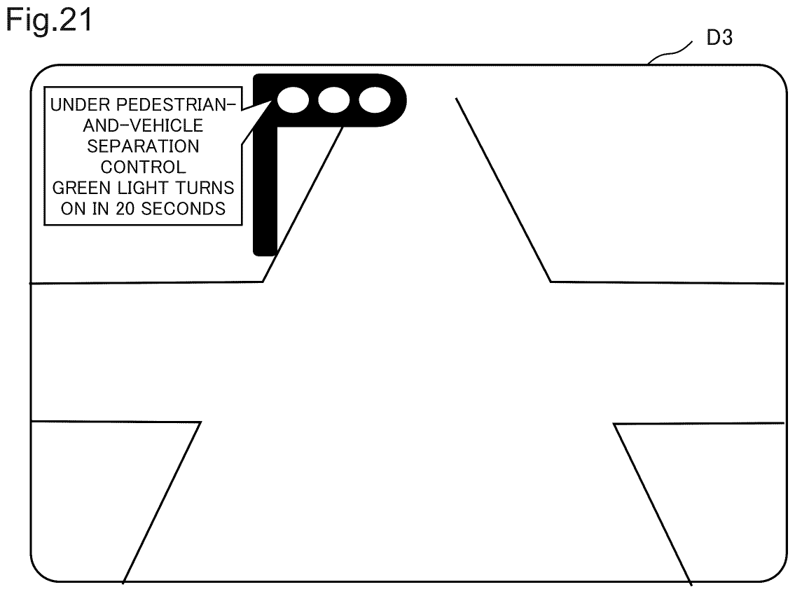

FIG. 21 is a diagram illustrating another example of the display mode of the vehicle on the in-vehicle terminal by the signal control system 100b of the present example embodiment. In the example of FIG. 21, the fact that the vehicle V operates in the “pedestrian-and-vehicle separation method” and the display of the remaining time until the emission of the signal is switched are added to the traffic light on the display screen D3 of the in-vehicle terminal of the vehicle V. That is, the display of a waiting time until the next phase by the signal control method being performed is added. In this way, a driver of a vehicle V can recognize that the traffic light at the intersection through which the vehicle is to pass is the traffic light that operates by the pedestrian-and-vehicle separation method and can recognize a time until the color of the light changes next. As a result, it is possible to prevent a hasty start and the like of the vehicle V after termination of the red light emission.

The display mode by the in-vehicle terminal can be variously modified, and a mode in which a head-up display projects and displays on a windshield can be adopted in addition to the display device installed in the vehicle. In addition to the display on various display devices, a notification of whether the “pedestrian-and-vehicle separation method” is adopted, the time until the signal is changed, and the like may be made by voice.

As described above, according to the present example embodiment, in addition to the display on the display board D, information regarding the signal control method can also be displayed on the in-vehicle terminal of the vehicle to notify the driver to call attention. The examples illustrated in FIGS. 20 and 21 are merely examples of the present example embodiment. For example, instead of displaying “green light turns on in 20 seconds” by the characters in FIG. 21, a time until the signal is switched by a counter or a figure may be presented. For example, it is possible to adopt a mode of presenting the remaining time until the signal in the signal control method being performed is switched by counter display of an inverse formula, or a mode of presenting the remaining time until the signal in the signal control method being performed is switched by counter display of displaying an elapsed time together with the value of the split. Instead of the display of a remaining time or the like by the numerical value described above, a mode of presenting a time at which the signal is switched next by increasing or decreasing a gauge can also be adopted.

In the present example embodiment, it has been described that the signal control system 100b notifies the in-vehicle terminal of the vehicle of the information regarding the signal control method; however, the same information may be provided to the pedestrian of the signal control system 100b. In this way, it is possible to prevent the pedestrian from starting to cross the crosswalk by misunderstanding.

### Fourth Example Embodiment

Next, a fourth example embodiment configured to extend a so-called all red time during the signal cycle before and after switching will be described in detail with reference to the drawings. Since the fourth example embodiment can achieve the same configuration as the first to third example embodiments, differences in operation will be mainly described below.

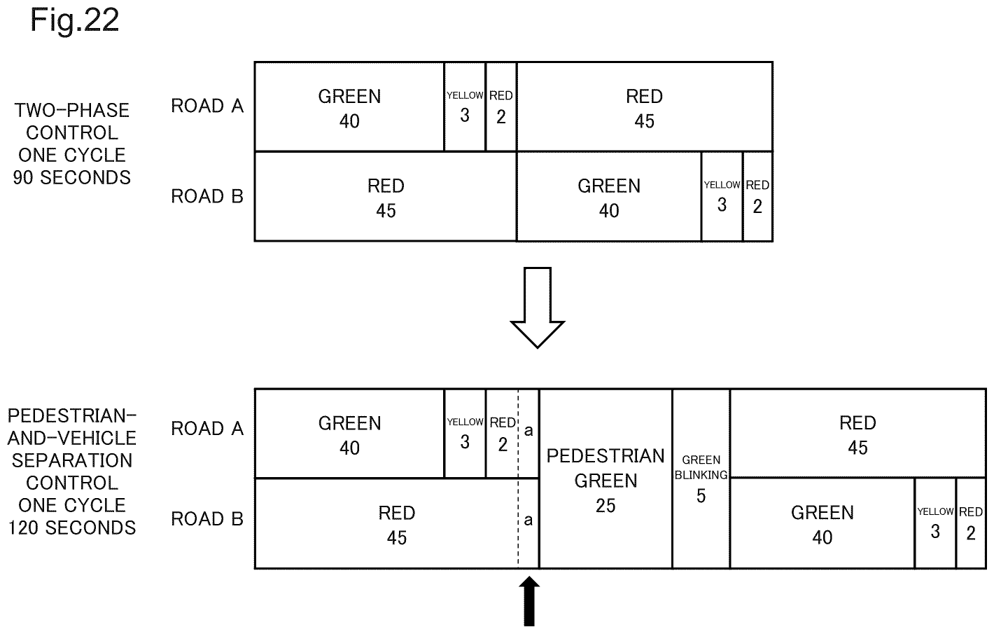

FIG. 22 is an example of a signal cycle diagram switched by the signal control system of the present example embodiment, and illustrates a signal cycle diagram before and after the change from the two-phase method to the pedestrian-and-vehicle separation method. A difference from the first example embodiment illustrated in FIG. 14 is that a signal control schedule is created in which a first all red time immediately after switching from the two-phase method to the pedestrian-and-vehicle separation method is extended by a seconds. Usually, in the case of two-phase control, when the traffic light of a road A changes from green, yellow, and red, the traffic light of a road B turns green (see an upper part of FIG. 22). However, when the signal control method is changed to the pedestrian-and-vehicle separation method, after the traffic light of the road A changes to green, yellow, and red, all pedestrian traffic lights S2 turn on green (see a lower part of FIG. 22). At that time, if the driver of the vehicle on the road B misunderstands that the signal control method is the two-phase method and does not stop or starts, the vehicle intersects with a pedestrian.

Thus, in the present example embodiment, as described above, the signal control schedule is adopted in which the first all red time immediately after switching from the two-phase method to the pedestrian-and-vehicle separation method is extended by a seconds. As a result, according to the present example embodiment, it is possible to urge the driver of the vehicle on the road B to stop, and it is possible to reduce the possibility of the occurrence of the intersection with the pedestrian.

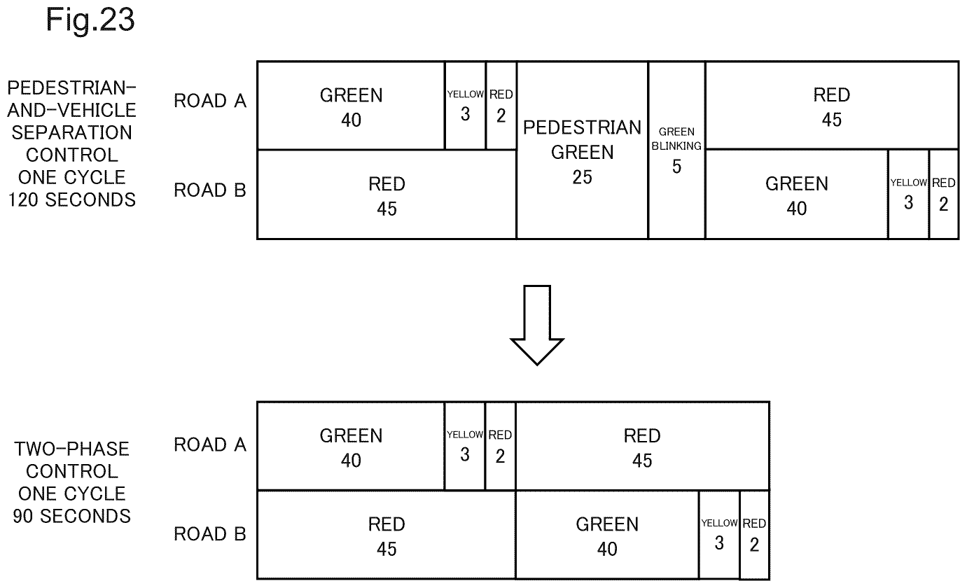

The same can occur when the pedestrian-and-vehicle separation method is switched to the two-phase method. FIG. 23 is an example of a signal cycle diagram at the time of switching from the pedestrian-and-vehicle separation method to the two-phase method. Also in this case, after the traffic light of the road A changes to green, yellow, and red, the time when all the pedestrian traffic lights S2 turn on green is skipped, and the traffic light of the road B changes to green. At that time, if the pedestrian misunderstands that the signal control method is the pedestrian-and-vehicle separation method and starts crossing the crosswalk, the intersection with the vehicle occurs.

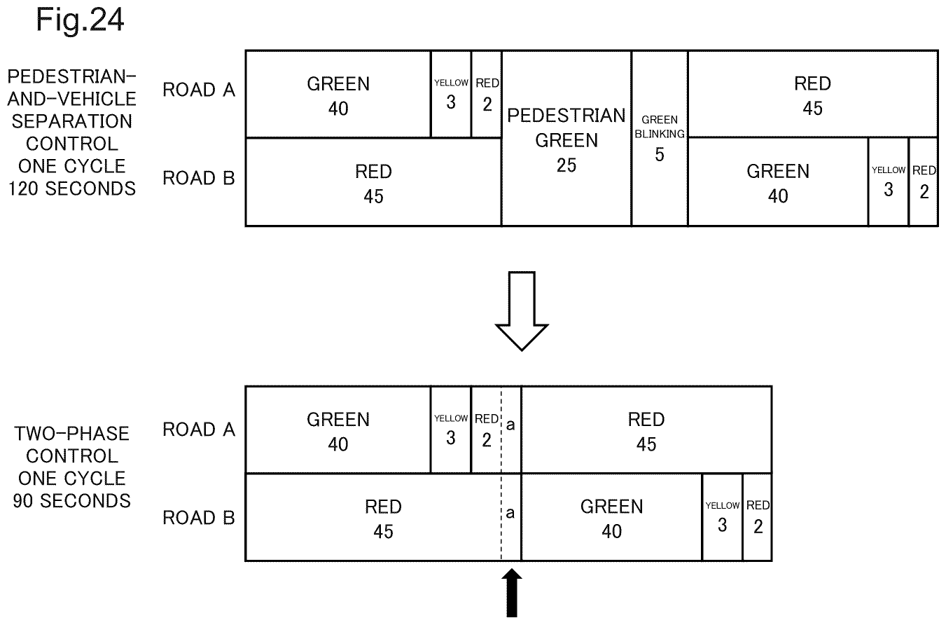

Thus, in the present example embodiment, as illustrated in FIG. 24, the signal control schedule is adopted in which the first all red time immediately after switching from the pedestrian-and-vehicle separation method to the two-phase method is extended by a seconds. As a result, according to the present example embodiment, it is possible to urge the pedestrian to wait on the sidewalk, and it is possible to reduce the possibility of the occurrence of the intersection between the pedestrian and the vehicle.

In the above example, it has been described that the first all red time immediately after switching from the two-phase method to the pedestrian-and-vehicle separation method and the first all red time immediately after switching from the pedestrian-and-vehicle separation method to the two-phase method are extended; however, the extension of the first all red time is not necessarily limited to once. If necessary, the signal control system 100 may repeat the above-described extension of the all red time for a plurality of cycles.

Although the embodiments of the present invention have been described, the present invention is not limited to the above embodiments, and further modifications, substitutions, and adjustments can be performed within the scope of the basic technological concept of the present invention. For example, the configuration of network, the configuration of each element, and the expression of the data shown in each drawing are examples to facilitate understanding of the present invention, and the present invention is not limited to the configurations shown in the drawings.

For example, in the first to fourth example embodiments described above, it has been described that the signal control systems 100 to 100b control signals; however, a mode in which the signal control systems 100 to 100b only create a signal control schedule can also be adopted. In this case, it is possible to take a mode in which the signal control systems 100 to 100b provide the signal control schedule to other signal control devices.

In addition, in the first to fourth example embodiments described above, the signal control systems 100 to 100b have been described to switch between the signal control methods at one intersection; however, a configuration in which the signal control systems 100 to 100b switch between the signal control methods at a plurality of intersections can also be adopted.

In addition, in the first to fourth example embodiments described above, it has been described that the vehicle has a traffic regulation for traveling on the left side of a road; however, the present invention can be similarly applied to countries with traffic laws that require the vehicle to travel on the right side of the road. In this case, the left and right in each of the above example embodiments are reversed. For example, the first evaluation value described above can be calculated using a statistical value of a right turn waiting time when a right-turning vehicle waits for passage of a pedestrian in front of a crosswalk located ahead of a right turn in the predetermined time in the past.

### (About Hardware)

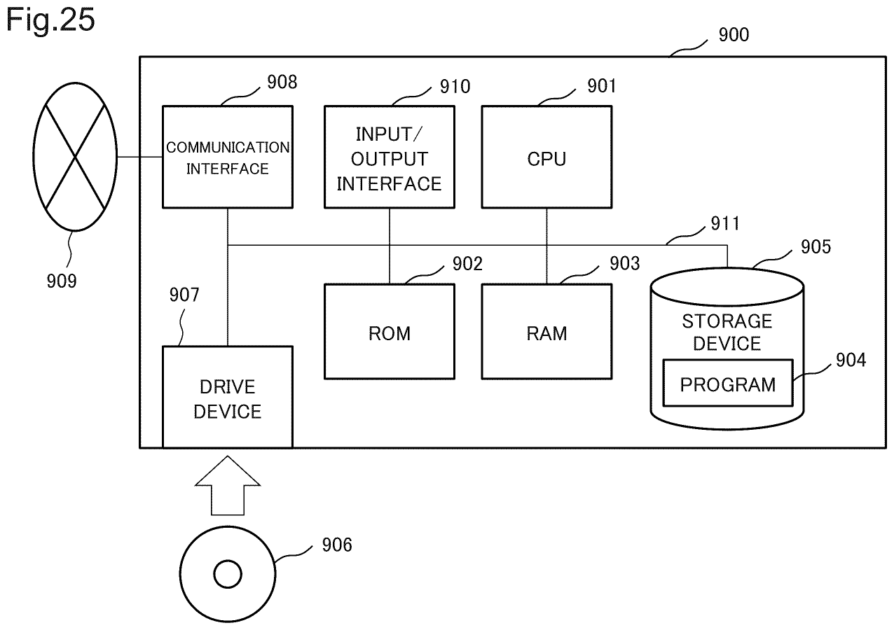

In each example embodiment of the present disclosure, each of components of the devices indicates a block on a function basis. A part or the entirety of the components of devices is achieved by any combination of, for example, an information processing device 900 as illustrated in FIG. 25 and a program. FIG. 25 is a block diagram illustrating an example of a hardware configuration of the information processing device 900 that achieves each component of each device. The information processing device 900 includes the following configuration as an example.
CPU (Central Processing Unit) 901
ROM (Read Only Memory) 902
RAM (Random Access Memory) 903
Program 904 loaded into RAM 903
Storage device 905 storing program 904
Drive device 907 that reads and writes recording medium 906
Communication interface 908 connected to communication network 909
Input-output interface 910 through which data is input and output
Bus 911 through which components are connected to each other

Each of the components of the devices in the example embodiments is achieved when the CPU 901 acquires and executes the program 904 achieving functions of the components. That is, the CPU 901 of FIG. 25 may execute a data acquisition program and a signal schedule creation program to perform update processing of each calculation parameter held in the RAM 903, the storage device 905, or the like. The program 904 for achieving the function of each component of each device is stored in the storage device 905 or the ROM 902 in advance, for example, and is read by the CPU 901 as necessary. The program 904 may be supplied to the CPU 901 via the communication network 909, or may be preliminarily stored on the recording medium 906, and the drive device 907 may read the program and provide the program to the CPU 901.

This program 904 can display processing results of the program including an intermediate state as necessary via a display device step by step or can communicate with the outside via the communication interface. In addition, this program 904 can be recorded in a computer-readable (non-transitory) recording medium.

The method for achieving each device has various modifications. For example, each device may be achieved by any combination of a separate information processing device 900 and a program for each component. In addition, a plurality of components included in the devices may be achieved by any combination of one information processing device 900 and a program. That is, each part (each processing means or function) of the signal control system described in the first to fourth example embodiments above can be achieved by a computer program causing a processor installed in the same device to execute each of the processes described above using the hardware of the system.

A part or the entirety of the components of the devices is achieved by another general or dedicated circuit, a computer, or a combination thereof. These may be formed by a single chip, or may be formed by a plurality of chips that are connected via a bus.

A part or the entirety of the components of devices may be achieved by a combination of the above-described circuit or the like and a program.

When a part or the entirety of the components of the devices is achieved by a plurality of information processing devices and circuits or the like, the plurality of information processing devices, circuits or the like may be arranged in a concentrated manner or may be arranged in a distributed manner. For example, the information processing devices and circuits or the like may be achieved in such a way that each of them is connected by a communication network, such as a client and server system or a cloud computing system.

Each of the above-described embodiments is a preferred embodiment of the present disclosure, and the scope of the present disclosure is not limited only to each of the above-described embodiments. That is, it is possible for those of ordinary skill in the art to make modifications and substitutions of the above-described embodiments without departing from the gist of the present disclosure, and to construct a mode in which various modifications are made.

Although a part or the entirety of the above-described embodiments may be described as in the following supplementary notes, the present invention is not limited thereto.

### Supplementary Note 1

A signal control system including:
a data acquiring means configured to acquire traffic status data related to movements of a vehicle and a pedestrian at an intersection for a predetermined time in the past;
a first calculating means configured to calculate first evaluation value based on the traffic status data; and
a creating means configured to create, based on the first evaluation value, a signal control schedule including timing at which pedestrian-and-vehicle separation type signal control is to be performed at the intersection.

### Supplementary Note 2

The signal control system may be configured to use, as the first evaluation value, a statistical value indicating a degree of stay of the vehicle due to intersection of traffic lines of the vehicle and the pedestrian in the predetermined time in the past.

### Supplementary Note 3

The signal control system may be configured to include a signal controller configured to switch between control methods for a traffic light at the intersection according to the created signal control schedule.

### Supplementary Note 4

The first calculating means of the signal control system may be configured to calculate the first evaluation value using a statistical value of a left turn waiting time when a left-turning vehicle waits for passage of a pedestrian in front of a crosswalk located ahead of a left turn in the predetermined time in the past.

### Supplementary Note 5

The first calculating means of the signal control system may be configured to calculate the first evaluation value using a statistical value of the left turn waiting time and a statistical value of a right turn waiting time when a right-turning vehicle waits for passage of a pedestrian in front of a crosswalk located ahead of a right turn in the predetermined time in the past.

### Supplementary Note 6

The first calculating means of the signal control system may be configured to calculate the first evaluation value using a statistical value of a time during which a pedestrian at a crosswalk located ahead of a left turn of a left-turning vehicle is located on the crosswalk in the predetermined time in the past.

### Supplementary Note 7

The first calculating means of the signal control system may be configured to calculate the first evaluation value for each of lanes facing each other at the intersection, in which the creating means creates, based on the first evaluation value, a signal control schedule, including the timing at which the pedestrian-and-vehicle separation type signal control is to be performed at the intersection.

### Supplementary Note 8

The data acquiring means of the signal control system may be configured to acquire traffic status data related to movements of the vehicle and the pedestrian at the intersection, in which the first calculating means calculates a first evaluation value for each time zone based on the traffic status data, and the creating means creates, based on the first evaluation value, a signal control schedule including timing at which the pedestrian-and-vehicle separation type signal control is to be performed at the intersection.

### Supplementary Note 9

The signal control system may be configured to further include a second calculating means configured to acquire, based on the traffic status data, a second evaluation value indicating a degree of decrease in traffic volume of straight-running vehicles per unit time when the pedestrian-and-vehicle separation type signal control is employed at the intersection, in which
the creating means creates, based on the first evaluation value and the second evaluation value, a signal control schedule for performing the pedestrian-and-vehicle separation type signal control at the intersection.

### Supplementary Note 10

The signal control system may be configured to further include a means configured to change a display content on a display board that displays a signal control method being performed at a traffic light at the intersection according to the signal control schedule.

### Supplementary Note 11

It may be configured in the signal control system that a counter or a figure indicating a waiting time until a next phase by the signal control method currently being performed is displayed on the display board.

### Supplementary Note 12

The signal control system may be configured to further include a means configured to notify a vehicle near the intersection of the signal control method being performed at a traffic light at the intersection according to the signal control schedule.

### Supplementary Note 13

It may be configured in the signal control system that a counter or a figure indicating a waiting time until a next phase by the signal control method currently being performed is notified to the vehicle.

### Supplementary Note 14

The signal control system may be configured to performs after signal control other than the pedestrian-and-vehicle separation type signal control is switched to the pedestrian-and-vehicle separation type signal control, signal control for extending an all red time in one cycle for a predetermined time.

### Supplementary Note 15

A method for creating a signal control schedule including:
acquiring traffic status data related to movements of a vehicle and a pedestrian at an intersection for a predetermined time in the past;
calculating a first evaluation value indicating a degree of stay of the vehicle due to intersection of traffic lines of the vehicle and the pedestrian in the predetermined time in the past based on the traffic status data; and
creating, based on the first evaluation value, a signal control schedule for performing pedestrian-and-vehicle separation type signal control at the intersection.

### Supplementary Note 16

A computer-readable recording medium storing a program for causing a computer to execute:
a process of acquiring traffic status data related to movements of a vehicle and a pedestrian at an intersection for a predetermined time in the past;
a process of calculating a first evaluation value indicating a degree of stay of the vehicle due to intersection of traffic lines of the vehicle and the pedestrian in the predetermined time in the past based on the traffic status data; and
a process of creating, based on the first evaluation value, a signal control schedule for performing pedestrian-and-vehicle separation type signal control at the intersection.

The modes of the supplementary notes 15 to 16 can be expanded to the modes of the supplementary notes 2 to 14, similarly to the supplementary note 1.

The disclosure of each Patent Literature cited above is incorporated herein in its entirety by reference thereto and can be used as a basis or a part of the present invention as needed. It is to be noted that it is possible to modify or adjust the example embodiments or examples within the scope of the whole disclosure of the present invention (including the claims) and based on the basic technical concept thereof. Further, it is possible to variously combine or select (or partially omit) a wide variety of the disclosed elements (including the individual elements of the individual claims, the individual elements of the individual example embodiments or examples, and the individual elements of the individual figures) within the scope of the disclosure of the present invention. That is, it is self-explanatory that the present invention includes any types of variations and modifications to be done by those of ordinary skill in the art according to the whole disclosure including the claims and the technical concept of the present invention. Particularly, any numerical ranges disclosed herein should be interpreted that any intermediate values or subranges falling within the disclosed ranges are also concretely disclosed even without specific recital thereof. In addition, as needed and based on the gist of the present invention, partial or entire use of the individual disclosed matters in the above literatures that have been referred to in combination with what is disclosed in the present application should be deemed to be included in what is disclosed in the present application, as a part of the disclosure of the present invention.

### REFERENCE SIGNS LIST

10, 100, 100a, 100b signal control system
11, 101 data acquiring means
12, 102 calculating means
13, 103, 203 creating means
14, 140 camera
15 signal control schedule
104, 304 signal controller
105 display board controller
106 per-time-zone stay time database (per-time-zone stay time DB)
107 second calculating means
108 signal control method notifying means
900 information processing device
901 CPU (Central Processing Unit)
902 ROM (Read Only Memory)
903 RAM (Random Access Memory)
904 program
905 storage device
906 recording medium
907 drive device
908 communication interface
909 communication network
910 input-output interface
911 bus
S1 vehicle traffic light
S2 pedestrian traffic light
D, D1, D2 display board

What is claimed is:

1. A signal control system comprising:
a memory; and
at least one processor coupled to the memory
the at least one processor performing operations to:
acquire traffic status data related to movements of a vehicle and a pedestrian at an intersection for a predetermined time in the past;
calculate a first evaluation value based on the traffic status data; and
create, based on the first evaluation value, a signal control schedule, including timing at which pedestrian-and-vehicle separation type signal control is to be performed at the intersection.

2. The signal control system according to claim 1, wherein
the first evaluation value is a statistical value indicating a degree of stay of the vehicle due to intersection of traffic lines of the vehicle and the pedestrian in the predetermined time in the past.

3. The signal control system according to claim 1, wherein the at least one processor further performs operation to:
switch between control methods for a traffic light at the intersection according to the created signal control schedule.

4. The signal control system according to claim 1, wherein the at least one processor further performs operation to:
calculate the first evaluation value using a statistical value of a left turn waiting time when a left-turning vehicle waits for passage of a pedestrian in front of a crosswalk located ahead of a left turn in the predetermined time in the past.

5. The signal control system according to claim 4, wherein the at least one processor further performs operation to:
calculate the first evaluation value using a statistical value of the left turn waiting time and a statistical value of a right turn waiting time when a right-turning vehicle waits for passage of a pedestrian in front of a crosswalk located ahead of a right turn in the predetermined time in the past.

6. The signal control system according to claim 1, wherein the at least one processor further performs operation to:
calculate the first evaluation value using a statistical value of a time during which a pedestrian at a crosswalk located ahead of a left turn of a left-turning vehicle is located on the crosswalk in the predetermined time in the past.

7. The signal control system according to claim 1, wherein the at least one processor further performs operation to:
calculate the first evaluation value for each of lanes facing each other at the intersection, and
create, based on the first evaluation value, a signal control schedule, including the timing at which the pedestrian-and-vehicle separation type signal control is to be performed at the intersection.

8. The signal control system according to claim 1, wherein the at least one processor further performs operation to:
acquire the traffic status data related to movements of the vehicle and the pedestrian at the intersection,
calculate the first evaluation value for each time zone based on the traffic status data, and
create, based on the first evaluation value, a signal control schedule including timing at which the pedestrian-and-vehicle separation type signal control is to be performed at the intersection.

9. The signal control system according to claim 1, wherein the at least one processor further performs operation to:
acquire, based on the traffic status data, a second evaluation value indicating a degree of decrease in traffic volume of straight-running vehicles per unit time when the pedestrian-and-vehicle separation type signal control is employed at the intersection, and
create, based on the first evaluation value and the second evaluation value, a signal control schedule for performing the pedestrian-and-vehicle separation type signal control at the intersection.

10. The signal control system according to claim 1, wherein the at least one processor further performs operation to:
change a display content on a display board that displays a signal control method being performed at a traffic light at the intersection according to the signal control schedule.

11. The signal control system according to claim 10, wherein the at least one processor further performs operation to:
display a counter or a figure, on the display board, indicating a waiting time until a next phase by the signal control method currently being performed.

12. The signal control system according to claim 1, wherein the at least one processor further performs operation to:
notify a vehicle near the intersection of the signal control method being performed at a traffic light at the intersection according to the signal control schedule.

13. The signal control system according to claim 12, wherein the at least one processor further performs operation to:
notify the vehicle of a counter or a figure indicating a waiting time until a next phase by the signal control method currently being performed.

14. The signal control system according to claim 1, wherein the at least one processor further performs operation to:
perform, after signal control other than the pedestrian-and-vehicle separation type signal control is switched to the pedestrian-and-vehicle separation type signal control, signal control for extending an all red time in one cycle for a predetermined time.

15. A method for creating a signal control schedule comprising:
acquiring traffic status data related to movements of a vehicle and a pedestrian at an intersection for a predetermined time in the past;
calculating a first evaluation value based on the traffic status data; and
creating, based on the first evaluation value, a signal control schedule for performing pedestrian-and-vehicle separation type signal control at the intersection.

16. A non-transitory computer-readable recording medium storing a program for causing a computer to execute:
acquiring traffic status data related to movements of a vehicle and a pedestrian at an intersection for a predetermined time in the past;
calculating a first evaluation value based on the traffic status data; and
creating, based on the first evaluation value, a signal control schedule for performing pedestrian-and-vehicle separation type signal control at the intersection.
